(19) United States
(12) Patent Application Publication
(10) Pub. No.: US 2017/0246793 A1
(43) Pub. Date: Aug. 31, 2017

(54) SYSTEM AND METHOD FOR EFFICIENT LAMINATION OF MATERIALS

(71) Applicant: MOBILE TOOL MANAGEMENT, INC., MUKILTEO, WA (US)

(72) Inventors: Chace Howard Fadlovich, Bothell, WA (US); Michael Gary Woogerd, Seattle, WA (US); Samantha Woogerd, Seattle, WA (US); Jeffrey Nelson, Mukilteo, WA (US)

(21) Appl. No.: 15/055,023

(22) Filed: Feb. 26, 2016

(51) Int. Cl. B29C 65/02; B29C 65/52

(52) U.S. Cl. CPC B29C 65/02; B29C 65/526

(57) ABSTRACT

A system for laminating two different materials together allows for an operator to adjust one or more aspects of the overall system in order to produce a more robust resultant product. A first material, such as a cloth material, may be laminated to a second material, such as a latex, while controlling various aspects of the two materials within the context of the system for producing the laminated materials. One aspect that may be controlled is the speed at which each material is fed into the system. Another aspect may be the angle at which each material is fed into a first set of rollers. A third aspect may be the tension in which each roll of material is held during the laminating procedure. A fourth aspect may be the temperature of one or more rollers in the system for bringing about the lamination and adhering of the two materials together.

### BACKGROUND

As manufacturing environments become more automated and complex, robotics and other automated machinery is becoming more and more prevalent in all phases of manufacturing. Very specific tasks that are conventionally performed by a skilled artisan may be performed by highly specialized machinery having highly specialized purposes. For example, manufacturing a pliable inner lining for an aircraft fuselage may include laminating a cloth material to a vinyl, latex, or similar material such that a resulting composition is well suited for providing strength and flexibility in a material used to cover inner walls of an aircraft fuselage.

In the past, common laminating machines may not be well suited for feeding more than two materials, for example, a cloth material a latex material, and a pressure sensitive adhesive (PSA), into a roll press section at the same time in an efficient manner as a typical laminating machine is designed to only feed one type of material into a roll press (e.g., a plastic sheet for lamination). Thus, using three different materials having different physical characteristics leads to a poor resultant laminated composition.

### BRIEF DESCRIPTION OF THE DRAWINGS

Aspects and many of the attendant advantages of the claims will become more readily appreciated as the same become better understood by reference to the following detailed description, when taken in conjunction with the accompanying drawings, wherein:

FIG. 1 shows a diagram of a lamination system having multiple rollers for multiple operations including laminating three different materials to each other according to an embodiment of the subject matter disclosed herein.

FIG. 2 shows a diagram of a heating controller of the lamination system of FIG. 1 for controlling heating of rollers in the system according to an embodiment of the subject matter disclosed herein.

FIG. 3 shows a diagram of a roller speed controller of the lamination system of FIG. 1 for controlling the speed of rollers in the system according to an embodiment of the subject matter disclosed herein.

FIG. 4 shows a diagram of a perforation system that may be part of the lamination system of FIG. 1 according to an embodiment of the subject matter disclosed herein.

FIG. 5 shows a flow chart of a method for controlling a laminating procedure using the system of FIG. 1 according to an embodiment of the subject matter disclosed herein.

### DETAILED DESCRIPTION

The following discussion is presented to enable a person skilled in the art to make and use the subject matter disclosed herein. The general principles described herein may be applied to embodiments and applications other than those detailed above without departing from the spirit and scope of the present detailed description. The present disclosure is not intended to be limited to the embodiments shown, but is to be accorded the widest scope consistent with the principles and features disclosed or suggested herein.

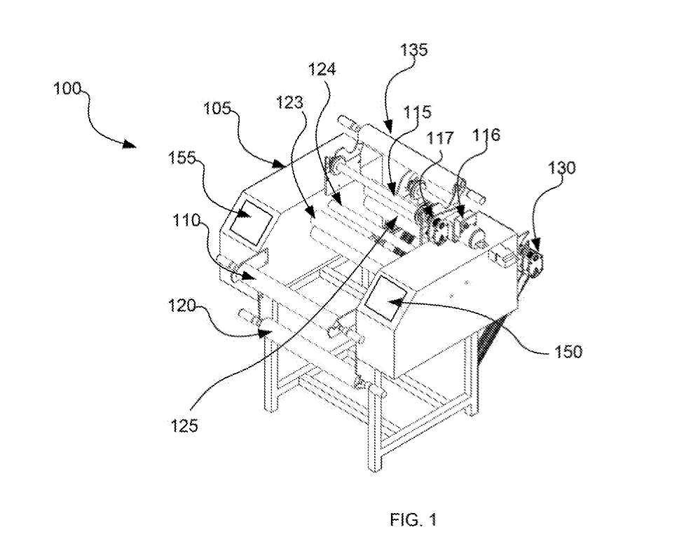

The subject matter disclosed herein is directed to a system and method for laminating three different kinds of materials to each other in an efficient and repeatable manner. In an embodiment, a system for laminating three different materials together allows for an operator to adjust one or more aspects of the overall system in order to produce a more robust resultant product. Thus, a first material, such as a cloth material, may be laminated to a second material, such as a latex, while controlling various aspects of the two materials within the context of the system for producing the laminated materials. One aspect that may be controlled is the speed at which each material is fed into the system. Another aspect may be the angle at which each material is fed into a first set of rollers. A third aspect may be the tension in which each roll of material is held during the laminating procedure. A fourth aspect may be the temperature of one or more rollers in the system for bringing about the lamination and adhering of the two materials together. These and other aspects of the subject matter disclosed herein are better understood with respect to the descriptions of FIGS. 1-5 below.

FIG. 1 shows a diagram of a lamination system 100 having multiple rollers for multiple operations including laminating three different materials to each other according to an embodiment of the subject matter disclosed herein. In general, the system of FIG. 1 may be well suited for laminating three materials of differing characteristics together. In the example embodiments throughout this disclosure, the three materials may be a cloth or mesh material, a latex material, and a PSA material. The cloth material may be a knit fabric having a mix of nylon and spandex. The latex material may be in the form of a latex sheet having a rating 130 psi under 300% modulus while having a tensile strength of about 4000 psi. The PSA material may be an adhesive transfer tape from a suitable manufacturer (such as F9465PC from 3M™). Other kinds of materials may be used in this process including vinyl, plastics, polyurethanes, and metals. Further, in one embodiment, the system 100 includes a number of rollers housed in a frame 105 and made from silicone rubber or the like. Such a silicone rubber material may provide enough flexibility for a good edge seal and firm enough to provide a good surface seal for materials being laminating together.

In laminating three materials together, considerations of the tensile strength applied to each material is taken into account when feeding the materials into the system 100. Thus, a first material may enter a roller at a first tension while a second material may enter the same roller at a second tension. Further, a third material may enter the same roller at a third tension or may enter a second roller at a third tension to be laminated with the two previous materials. The tension of each material may be further affected by the speed in which the materials are fed into the system 100. Further yet, the tension may be further affected by an angle in which the materials are fed into various rollers in the system 100. By carefully controlling the tension, feed angle, and speed, embodiments of the laminating machine described further below produce a resulting laminated product that is superior to other products in the marketplace.

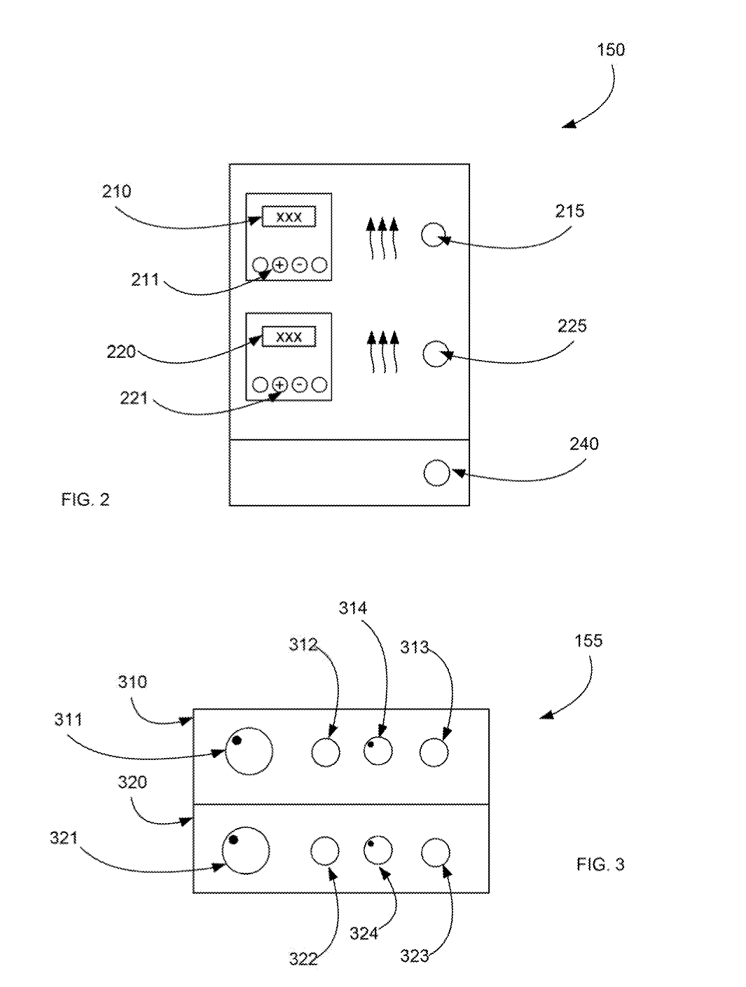

In readying the system 100 for a lamination procedure, a first feed roller 120 may be stocked with a first material such as the cloth material (not shown). Further, a second feed roller 110 may be stocked with a second material such as the PSA material (also not shown). Typically, the PSA material includes an adhesive side covered by a removable covering layer. As the PSA layer is fed through and exits a first set of hot rollers 123, the removable covering may be peeled from the PSA material such that the adhesive layer (without the removable covering) and the cloth are fed through the first set of hot rollers 123 with the adhesive side of the latex facing the cloth. The first set of hot rollers may be a pair of silicon rubber rollers configured to pinch the first material and the second material together. Further, the first set of hot rollers 123 may have a specific adjustable temperature in order to initiate the adhering of the cloth material to the PSA material. The temperature of the first set of roller 123 may be controlled by setting a specific controlled temperature of a heating element (not shown in detail) disposed inside of each roller in the first set of hot rollers 123. Such a laminating temperature may be 135 degrees Fahrenheit. Generally speaking, the temperature aspects of the system 100 may be controlled by a temperature control panel 155 discussed below with respect to FIG. 2.

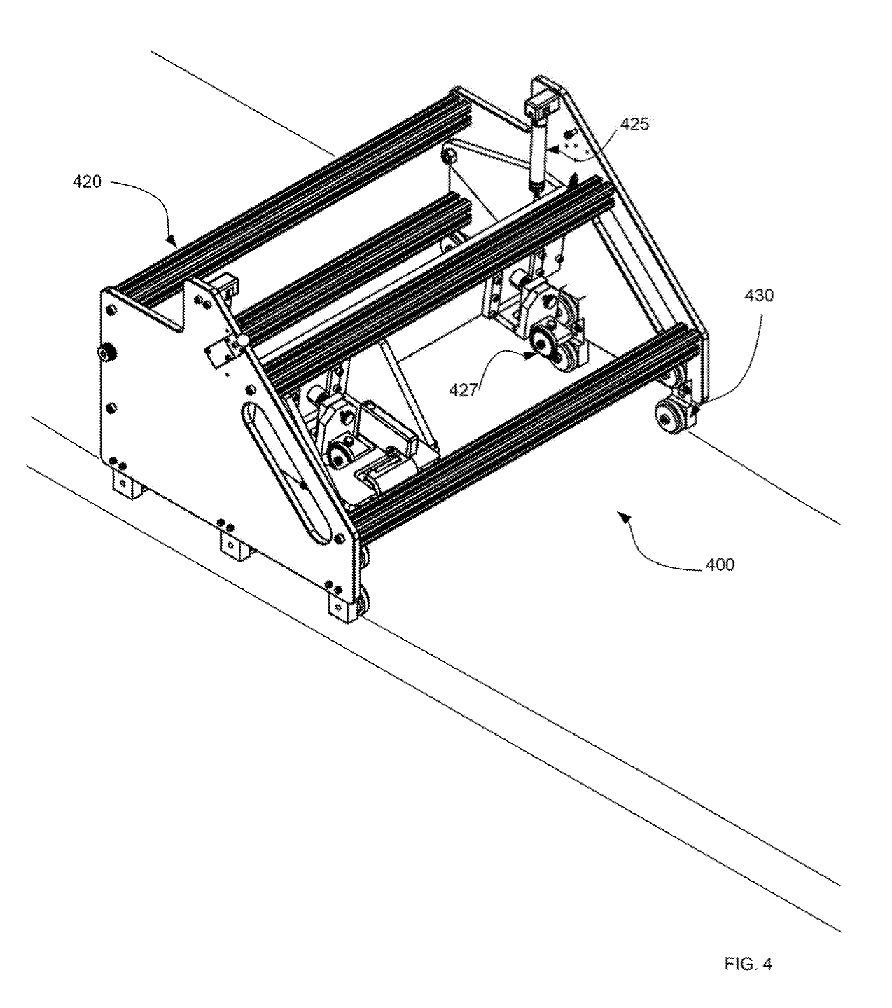

The adhesive side of the PSA material faces the cloth material as is enters the first set of hot rollers 123. Further, the removable covering may be peeled from the PSA material with the help of a take-up roller 115. Thus, the cloth material and the PSA material may enter the first set of hot rollers 123 having a specific set tension and speed. Such speed and tension may be controlled through speed control panel 150 which is discussed below with respect to FIG. 3. The tension and speed may differ so as provide for optimal adhesion to each other as speed of the first set of hot rollers 123 may be determined based on controlling a motor 116 driving the first set of hot rollers 123. For example, the cloth material may be set to have a greater tension when entering the first set of hot rollers than the tension of the PSA material that is entering the first set of hot rollers 123. This may be achieved by having slightly differing speeds when entering the first set of hot rollers 123 for each material and by adjusting a tension control housed at an end of each feed supply roller 110 and 120.

In another aspect of optimizing lamination at the first set of hot rollers 123, the specific angle at which the materials are fed to the first set of hot rollers 123 may be adjusted. Thus, in one embodiment, the first feed roller 110 supplies the first material to the first set of hot rollers 123 at a first angle and the second feed roller 120 supplies the second material to the first set of hot rollers 123 at a second angle. The first angle comprises approximately ten degrees with respect to the plane of the laminated materials exiting the first set of hot rollers 123 and the second angle comprises approximately thirty degrees (30 degrees as is enters from below the plane) with respect to a plane of laminated materials exiting the first set of hot rollers 123.

Further, the take-up roller 115 may set a specific speed and tension for the collection of the removable covering of the PSA material. The take-up roller 115 may also have an associated motor 117 for controlling speed and tension (as controlled by speed control panel 150). Each roller in the system 100 may further have associated motors, although not all are shown in FIG. 1 for clarity. Aspects of speed and tension of the various materials are discussed further below with respect to FIGS. 2-3.

As the combined materials exit the first set of hot rollers 123, a tension roller 124 may provide an adjustment to tension to the combined materials before the combined materials enter a second set of hot roller 125. That is, the tension roller 124 may have a lateral adjustment such that the tension roller may be moved closer towards or away from the plane of the cloth/PSA laminated interim product in order to increase or decrease the tension on the cloth/PSA interim product at this point on the procedure. The second set of hot rollers 125 may have an increased temperature with respect to the first set of hot rollers 123 in order to fully adhere the cloth material to the PSA material. Such a temperature may be 135 degrees Fahrenheit. Each set of hot rollers 123 and 125 have individual heat controls such that a specific temperature may be set for each set independently.

At the second set of hot rollers 125, a third material, a latex material in this embodiment, may be added to the laminated product. Thus, a third feed roller 135 may supply a third material (latex) to the process. The second set of hot rollers 125 provides heat to adhere all three materials together to form a final laminated product. Speed and tension of the third feed roller 135 may be controlled through speed control panel 150 which is discussed below with respect to FIG. 3. The tension and speed may differ so as provide for optimal adhesion to each other as speed of the second set of hot rollers 125 may be determined based on controlling a motor 116 driving the second set of hot rollers 125. For example, the cloth/PSA material (that just exited the first set of hot rollers 123) may be set to have a greater tension when entering the second set of hot rollers 125 than the tension of the latex material that is entering the second set of hot rollers 123. This may be achieved by having slightly differing speeds when entering the second set of hot rollers 123 for each material and by adjusting a tension control housed at an end the third feed supply roller 135.

In another aspect of optimizing lamination at the second set of hot rollers 125, the specific angle at which the materials are fed to the second set of hot rollers 125 may be adjusted. Thus, in one embodiment, the third feed roller 135 supplies the third material to the second set of hot rollers 123 at a first angle and the interim product exiting the first set of hot rollers 123 is fed at a second angle. The first angle comprises approximately ninety degrees with respect to the plane of the interim product exiting the first set of hot rollers 123 and the second angle cis the plane of interim product exiting the first set of hot rollers 123.

As the combined materials exit the second set of hot rollers 125, the resultant laminated material may be taken up is an exit take-up roller 130 having a take-up roller motor that may be controlled through speed control panel 155. The exit take-up roller 130 may include controls for adjusting speed and tension as well. Further, all rollers in the system 100 may be spring loaded to provide for a more even tension or lamination pressure during a lamination procedure. Such spring-loaded pressure is also adjustable for each individual roller.

As briefly discussed above, the optimization of lamination may be achieved by carefully controlling several system parameters of the system 100. These parameters include the tension of each material, the speed of each material, the feed angles of each material, the take up angles of each material, and the temperature of each set of hot rollers 123 and 125.

FIG. 2 shows a diagram of a heating controller 155 of the lamination system 100 of FIG. 1 for controlling heating of rollers in the system 100 according to an embodiment of the subject matter disclosed herein. In this embodiment, two different heating controls are shown for separating driving a heating element of two different rollers (or sets of rollers. Thus a first temperature controller 210 may be used to set a specific temperature for the first set of hot rollers 123 (FIG. 1) and a second temperature controller 220 may be used to set a specific temperature for the second set of hot rollers. In other embodiments, these two controllers 210 and 220 may be used to control temperature for any combinations or groupings of rollers in the overall system. In general, each heating element controlled by each heating controller 210 and 220 may be between 4000 and 7000 watts

Each temperature controller 210 and 220 may operate independent of the other. Thus, the first temperature controller 210 includes temperature up and down controls 211 in addition to specific control to drive particular functions such as ramping, pre-heat and the like. Further yet, the heater may be engaged or disengaged through an engage heat actuator 215. Likewise, the second temperature controller 220 also includes temperature up and down controls 221 in addition to specific control to drive particular functions such as ramping, pre-heat and the like. Again, the heater associated with the second controller 220 may be engaged or disengaged through an engage heat actuator 225. In one specific embodiment, the rollers to be heated using heating elements controlled by these temperature controllers 210 and 220 may be preheated prior to threading materials through the lamination system in order to ensure optimal adhesion for the entirety of the process.

FIG. 3 shows a diagram of a roller speed controller 150 of the lamination system 100 of FIG. 1 for controlling the speed of rollers, via a controlled variable speed motor, in the system 100 according to an embodiment of the subject matter disclosed herein. Each motor that is controlled may be ¼ HP direct current motor with 240V single phase 60 hertz according to an embodiment. In this embodiment, there are two speed controllers for controller two different rollers. A first speed controller 310 is shown in FIG. 3 and may be used to control the speed of a motor driving a first take-up roller 130. The speed may be controlled to have a variable speed up to 30 feet per minute. Generally, thicker applications, such as when cloth and latex are adhered to each other, should be applied at mid-range to high speeds (within the range of 0 to 30 feet per minute). Thus, the speed setting control 311 may be set to a desired speed by an operator. Further, an operator may use controls to start 312 or stop 313 the motor as well as select forward or reverse 314.

A second roller may also be controlled in this embodiment using a second speed controller 320. Such a second controlled roller may be the waste pickup roller 115. Thus, the speed setting control 321 may be set to a desired speed by an operator. Further, an operator may use controls to start 322 or stop 323 the motor as well as select forward or reverse 324.

Further, tension may be adjusted at any roller, in particular supply rollers 110, 120 and 130 that will affect the speed of the operation. Supply roll tension control allows for tightening or loosening of the tension of supply. Tension may be adjusted at one or more control knobs on various mandrels of the supply rolls (not shown in detail).

FIG. 4 shows a diagram of a perforation system 400 that may be part of the lamination system of FIG. 1 according to an embodiment of the subject matter disclosed herein. In FIG. 4, the perforation system is shown as separate from the system 100 of FIG. 1. Thus, an operator may remove a full (or partially full) take-up roll 130 of laminated material (e.g., the finished product of the system of FIG. 1) and physically transport the take-up roll to be placed at the first roller 420 position of the perforation system 400. In an alternative embodiment, the first roller 420 shown in FIG. 4 may be the take-up roll 139 as shown in FIG. 1 if the system 100 of FIG. 1 and the perforation system of FIG. 4 are combined to form one overall system. As a full roll of laminated material is loaded onto the first roller 420, a leading edge may be fed into a perforator 425 and then fed to a guide roll 430.

The perforator 425 perforates one or both side edges of the laminated material. The perforations may be spaced evenly as the material is fed through the perforator. Further, an edge slicer 427 may trim the edges of the laminated material such that a uniform width of laminated material results with specifically measured perforations at a specific distance from one or both edges.

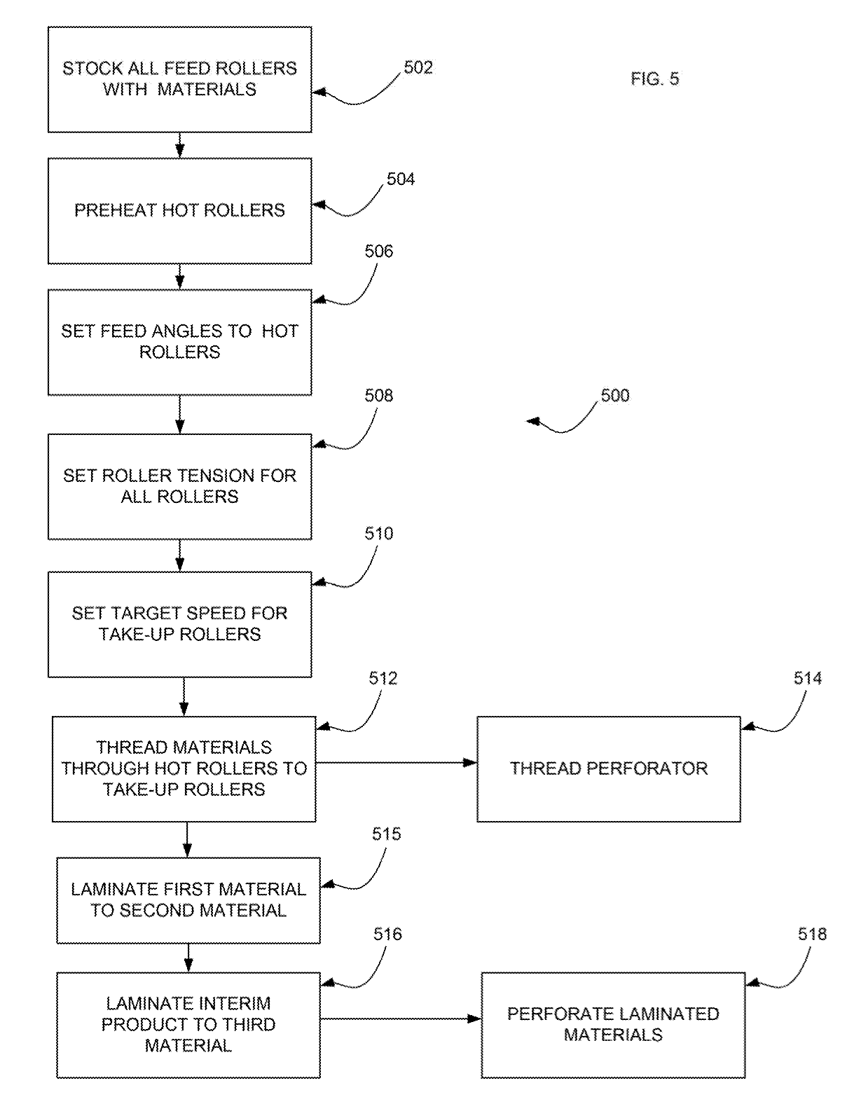

FIG. 5 shows a flow chart of a method for controlling a laminating procedure using the system of FIG. 1 according to an embodiment of the subject matter disclosed herein. In specific, the method 500 shown includes steps for feeding a first material to a first hot roller at a first tension, feeding a second material that is different than the first material to the first hot roller at a second tension that is different than the first tension; and laminating the first material to the second material. Thus, at a first step 502, first, second, and third feed rollers may be stocked with respective first, second, and third materials. At step 504, the hot rollers may be preheated to a specific laminating temperature. Preheating the hot rollers ensures that even the initial portions of the materials being fed through the system are efficiently and evenly laminated to each other.

In preparing the system for a lamination procedure, various feed angles may be set by an operator prior to operation at step 506. Thus, the first material is fed to the first hot roller at a first angle and the second material is fed to the first hot roller at a second angle that is different from the first angle. Further, the third material is fed to the second set of hot rollers at a third angle. As discussed above, a change in the feed angle affects the tension in which the material exhibits while moving through the rollers of the system. Further, specific tensions of specific rollers may be set by an operator at step 508 to further control the specific tension of the two materials during operation.

At step 510, an operator may set a speed control to a target speed for the take-up roll motor. In achieving the target speed for the take-up roller, the first material is fed to the first hot roller at a first speed, the second material is fed to the first hot roller at a second speed that is different from the first speed, and the third material is fed to the second set of hot rollers at a third speed. Having the differing speeds assists with achieving lamination as the materials, having different tensile strength, behave differently throughout the rollers of the system.

As each aspect of the system is set by an operator, the materials may be threaded through, at step 512, the various rollers of the system as described above with respect to FIG. 1. Further, the resultant product may also be threaded through an optional perforation system at step 514. When properly threaded, the system may be engaged and the target speed is approached and reached in a ramp-up manner. As the system ramps up to the target speed, the first and second materials are laminated at the first set of hot rollers at step 515 and the interim product and the third material are laminated at the second set of hot rollers at step 516. The final product may then be perforated at step 518 if the optional perforation system is attached.

As a result of achieving the target speed or ramping up to the target speed, the feeding of the first and second materials from the exit of the first set of hot rollers to the second set of hot rollers happens at third tension and at a second speed. That is, the tension between the first and second of hot rollers and the speed at which the materials are propagating is different from the initial speeds and tension prior to the first set of hot rollers. An operator may adjust the target speed up or down whereby adjusting the speed of the hot roller is done so inversely proportional to the tension of the first and second materials being fed to the hot roller.

While the subject matter discussed herein is susceptible to various modifications and alternative constructions, certain illustrated embodiments thereof are shown in the drawings and have been described above in detail. It should be understood, however, that there is no intention to limit the claims to the specific forms disclosed, but on the contrary, the intention is to cover all modifications, alternative constructions, and equivalents falling within the spirit and scope of the claims.

What is claimed is:

1. A laminating machine, comprising:
a hot roller configured to receive a first material and a second material and to apply laminating heat to the first and second materials;
a motor coupled to the hot roller and configured to turn the hot roller at a speed;
a first feed roller for supplying the first material to the hot roller at a first tension; and
a second feed roller for supplying the second material to the hot roller at a second tension different from the first tension.

2. The laminating machine of claim 1, wherein the hot roller comprises a pair of silicon rubber rollers configured to pinch the first material and the second material together.

3. The laminating machine of claim 1, wherein the first material comprises a cloth material and the second material comprises a latex material having an adhesive side.

4. The laminating machine of claim 1, wherein the hot roller further comprises a heating element configured to heat the hot roller to a first temperature.

5. The laminating machine of claim 1, wherein the first tension is greater than the second tension

6. The laminating machine of claim 1, wherein the first feed roller supplies the first material to the hot roller at a first angle and the second feed roller supplies the second material to the hot roller at a second angle

7. The laminating machine of claim 6, wherein the first angle comprises approximately 135 degrees and the second angle comprises approximately 135 degrees with respect to a plain of a resulting laminated cloth and latex material exiting the hot roller.

8. The laminating machine of claim 1, further comprising a speed controller coupled to the motor and configured to adjust the speed of the hot roller.

9. The laminating machine of claim 1, further comprising a temperature controller coupled to the hot roller and configured to adjust the temperature of the hot roller.

10. The laminating machine of claim 1, further comprising a second hot roller configured to receive the first and second material from the first hot roll and further configured to provide further laminating heat to the first and second materials.

11. The laminating machine of claim 1, further comprising a take-up mechanism configured to collect the first and second materials after lamination.

12. The laminating machine of claim 11, wherein the take-up mechanism is further configured to perforate edges of the first and second materials after lamination.

13. The laminating machine of claim 1, further comprising a tension roller configured to provide tension to the first and second materials after exiting the hot roller.

14. A method for laminating materials, comprising:
feeding a first material to a first hot roller at a first tension;
feeding a second material that is different than the first material to the first hot roller at a second tension that is different than the first tension; and
laminating the first material to the second material.

15. The method of claim 14, wherein the first material is fed to the first hot roller at a first angle and the second material is fed to the first hot roller at a second angle that is different from the first angle.

16. The method of claim 14, wherein the first material is fed to the first hot roller at a first speed and the second material is fed to the first hot roller at a second speed that is different from the first speed.

17. The method of claim 14, further comprising heating the first hot roller to a first temperature.

18. The method of claim 14, further comprising feeding first and second materials to second hot roller at a third tension and at a second speed.

19. The method of claim 14, further comprising adjusting the speed of the hot roller inversely proportional to the tension of the first and second materials being fed to the hot roller.

20. The method of claim 14, further comprising perforating edges of the laminated first and second materials in a repeating pattern.
